(19) United States
(12) Patent Application Publication
(10) Pub. No.: US 2017/0243155 A1
(43) Pub. Date: Aug. 24, 2017

(54) RACK OF AN INVENTORY MANAGEMENT SYSTEM FOR PROVIDING PRODUCTS

(71) Applicant: Würth Industrie Service GmbH & Co. KG, Bad Mergentheim (DE)

(72) Inventor: Dietmar Reuter, Langenburg (DE)

(21) Appl. No.: 15/435,016

(22) Filed: Feb. 16, 2017

(30) Foreign Application Priority Data
Feb. 19, 2016 (DE) 20 2016 100 875.1

(51) Int. Cl. G06Q 10/08; A47F 7/28; A47F 10/02; A47F 7/14; A47F 1/12; A47F 5/10

(52) U.S. Cl. CPC G06Q 10/087; A47F 1/126; A47F 5/108; A47F 10/02; A47F 7/14; A47F 7/28; A47F 2010/025

(57) ABSTRACT

Rack of an inventory management system for providing products, comprising:
a. two side elements,
b. at least one front and one rear horizontal element,
   i. wherein these connect the two side elements,
c. at least one product carrier for reception of same products,
   i. which product carrier is plugged in the front and the rear horizontal elements, and
   ii. has a distinct identification,
d. a measurement device for at least one product carrier,
   i. which measurement device measures the filling level of the product carrier with products,
e. a connection unit, with which data from the measurement device concerning the filling level of the product carrier with products and the identification of the product carrier are transmissible to a centre of an inventory management system, in order to trigger at least one re-ordering of products for a product carrier.

This application claims the benefit of the filing date of German Application DE 20 2016 100 875 filed 19 Feb. 2016, the disclosure of which is hereby incorporated herein by reference.

### FIELD OF THE INVENTION

The invention relates to a rack of an inventory management system for providing products.

### TECHNOLOGICAL BACKGROUND

Nowadays, high requirements are set for an inventory management system: On the one hand, all products should be present permanently to a sufficient degree, and on the other hand, the stock (or inventory) should preferably be low, in order to keep the cost for the products in the store (or warehouse) as low as possible. Against this background, modern inventory management systems comprise a number of racks having shelf compartments, in which products are arranged. The stock of products in the shelf compartments can be measured by means of different methods and can be transmitted to a centre (or control centre) of an inventory management system. If the number of products of a specific product falls below a previously determined threshold value, the inventory management system “warns” a person in charge of ordering, who thereupon triggers a re-ordering of the product, refer for example to DE 10 2013 222 263 or EP 02 390 204.

Thereby, an inventory management system may contain a large number of goods in the products, for example several ten or hundred thousand different goods. A product may be a paperboard (or paperboard package), an aerosol can, a canister, a small load carrier with or without removal flap, or an inlay element, for example for a drawer. Thereby, bolts or nuts or the like may be arranged as goods in the paperboard (package). Paints, brake cleaning agents or cleaning agents may be contained as goods in the aerosol cans. Oils, antifreeze agents for vehicles or cleaning agents may be contained as goods in the canisters. Small parts of any kind, for example bolts, seals and nuts, may be stored as goods in the small load carriers, for example according to DE 10 2014 105 871 or DE 10 2012 017 295. An inlay element for a drawer in, for example, a mobile workshop is typically a deep-drawing element, in which different compartments may be formed for goods in the form of small components, for example for electronic clamps, bolts, nuts, etc.

Generally, several products are arranged in a shelf compartment, the stock of which is detected with a measurement device, respectively. If a product is to be taken out of the assortment of goods of the inventory management system, or if the storage cell of a product is to be changed from one position to another position, expensive structural alteration measures are necessary, because things have to be rebuilt at/in the rack and also the software for the detection of the stock of the product including the associated measurement device must be modified and/or adapted.

### SUMMARY OF THE INVENTION

There may be a need for a rack for an inventory management system, by means of which modifications in the rack can be made in a simple manner.

According to an embodiment of the invention, a rack having the features of claim 1 and an inventory management system having at least one such rack are provided.

### DETAILED DESCRIPTION OF EXEMPLARY EMBODIMENTS

Racks for inventory management systems according to the state of the art have shelf compartments for products, which have variable sizes (or dimensions). It is here that an embodiment of the present invention applies, by reducing the possible width of products to a predetermined small number of widths, and by providing, for each these widths, a product carrier which has a reception width that corresponds to one of the possible widths of products. Thereby, all products and thus all goods of an inventory management system can be arranged on a suitable product carrier out of a limited number of possible product carriers, which product carrier is then arranged in the rack, thereby, in one embodiment example, being carried in the front and in the back by a horizontal element. A measurement device is assigned to each product carrier, which measurement device detects the stock of products on the product carrier. An identification of the product carrier and a stock of products on the product carrier can be transmitted to a (control) centre of an inventory management system by means of a connection unit, in order to trigger a re-ordering operation.

In other words, thus each product and thus each good is arranged in the rack on a proper (own) “tray”, which measures the number of the products on the tray and transmits this to a (control) centre of the inventory management system. The trays (respectively product carriers) can be shifted and/or rearranged in the rack in a simple manner, by simply being taken out of the rack and put into the rack at another position. In this way, the storage cell of a product within the rack is “relocated”, without further rebuilding works having to be performed.

A side element may be formed as a side panel or by at least two rack rods, in each case particularly made of metal.

Preferably, the horizontal element is a bar (or raker), particularly a metal bar, which preferably has a hole grid.

Preferably, a predetermined number of product carriers having different reception width is assigned to the rack, wherein each of the products of an assortment of goods of the inventory management system has a size (or dimension) which corresponds to a reception width of a product carrier.

Preferably, a product carrier has a product carrier bottom, two product carrier sides, a product carrier front side and a product carrier rear side as well as plug noses, which are advantageously arranged at the product carrier bottom, opposite to the product carrier sides, and which are pluggable in a hole grid of the horizontal elements.

Advantageously, the product carrier comprises a, particularly spring-loaded, product pusher, which pushes same products arranged on the product carrier in a direction of the product carrier front side.

Thereby, advantageously, a reception width of the product carrier is formed by the distance of the product carrier sides.

A ratio of a number of different goods of the inventory management system to a number of different product carriers of the rack is preferably like at least 100:1, preferably like at least 1,000:1, and more preferably like at least 10,000:1.

A product may be a paperboard (or paperboard package), an aerosol can, a canister, a small load carrier with or without removal flap, or an inlay element, for example for a drawer.

The measurement device may comprise an ultrasound transmitter and receiver or a linear measurement device, in order to determine a length between the product carrier front side of the product carrier and a product pusher, between which the same products are arranged, in order to determine the number of products between them and/or on the product carrier.

The identification of the product carrier may comprise an identification element on the product carrier, for example a bar code or a QR-code, and/or an identification element in the measurement device, for example a MAC address, a bar code or a QR-code.

The connection unit comprises advantageously a data logger and a transmission medium, for example a wire-bound or wireless connection line, to an inventory management system, such that the data of the measurement devices are collected by the data logger and are transmissible to a centre (or control centre) of the inventory management system by means of the transmission medium.

Further features, details and advantages of embodiments of the invention result from the claims and the following description of preferred embodiments as well as on the basis of the drawings. In the drawings:

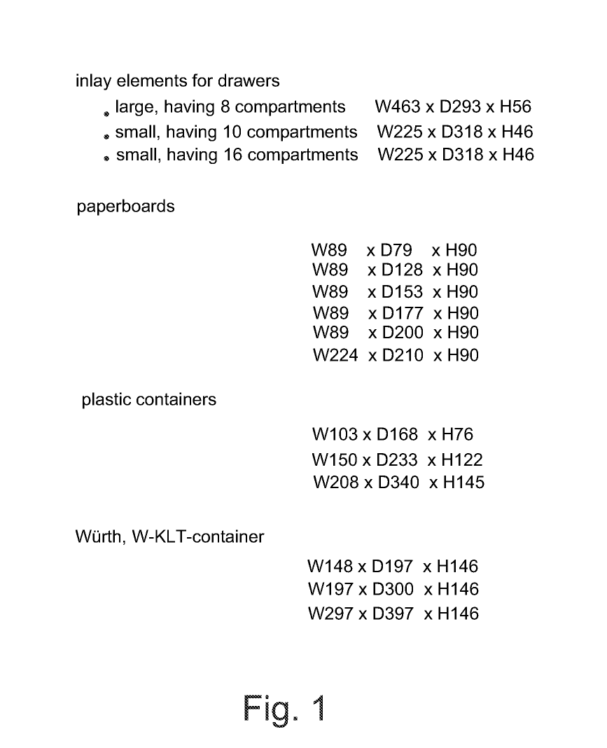

FIG. 1 shows, for different products of an inventory management system, the respective dimensions, in which it is present in the inventory management system,

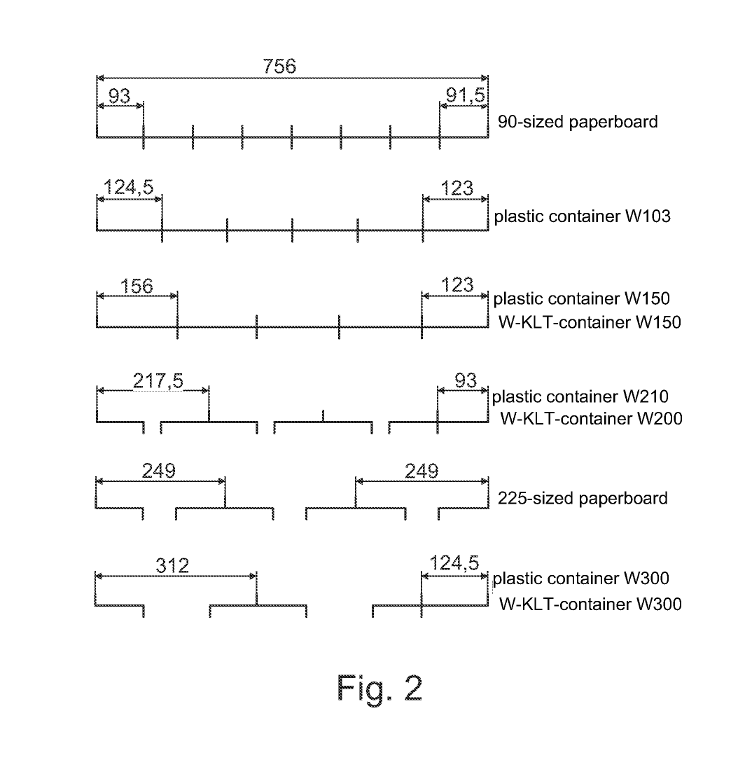

FIG. 2 shows a front view of product carriers, having different widths, of a rack according to an embodiment of the present invention,

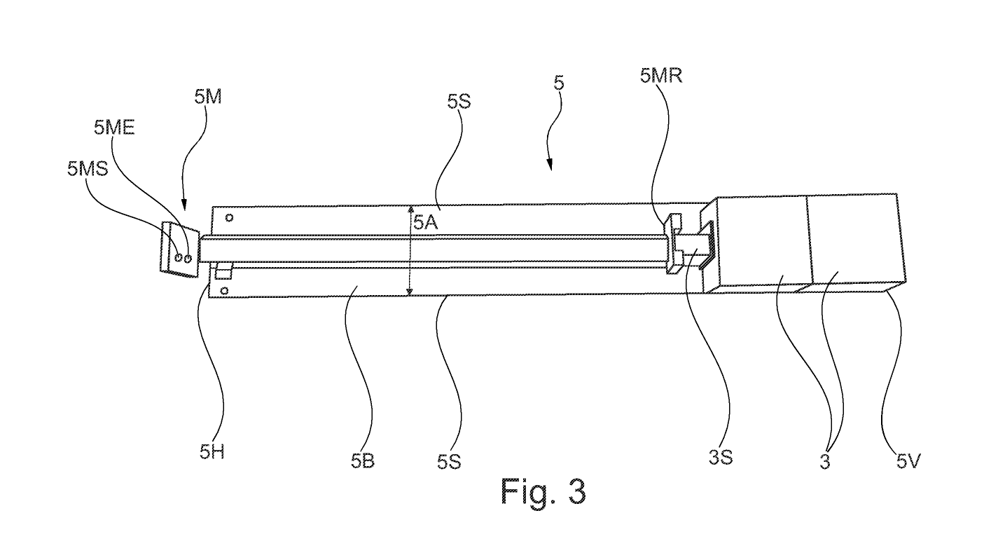

FIG. 3 shows a perspective view of a product carrier, on which two products are arranged, which are pushed by a product pusher to a product carrier front side,

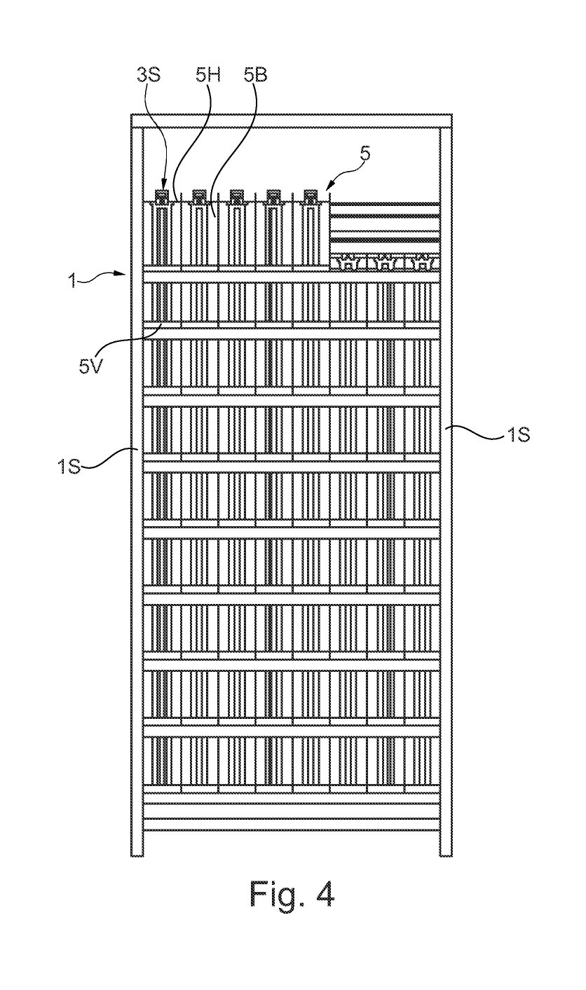

FIG. 4 shows a front view of a rack according to an embodiment of the invention,

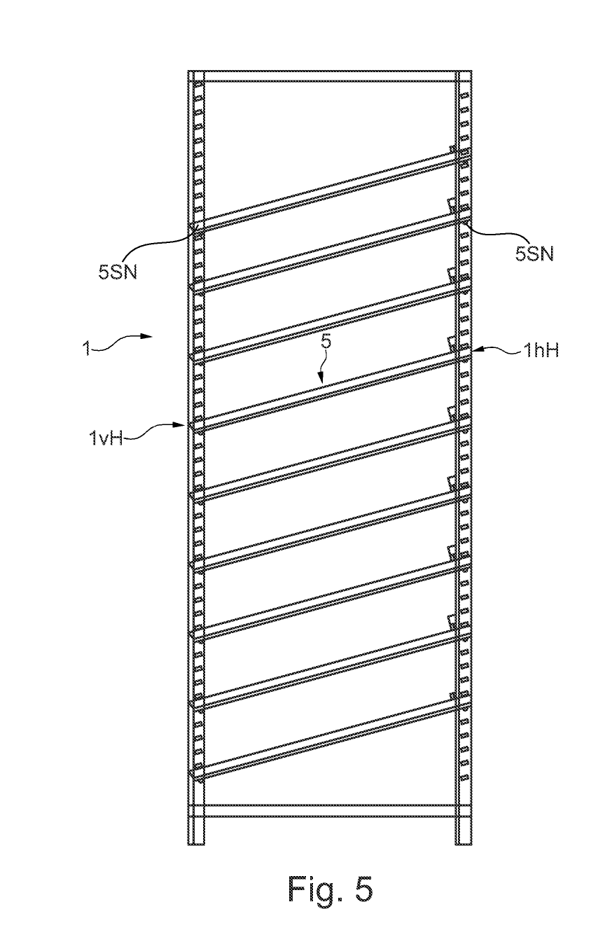

FIG. 5 shows a side view of the rack of FIG. 4,

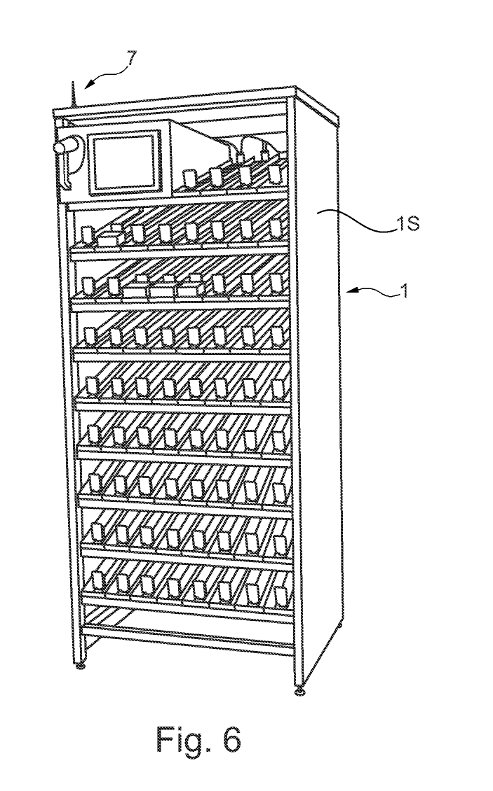

FIG. 6 shows a perspective view of a rack according to an embodiment of the invention, according to a further embodiment example, and

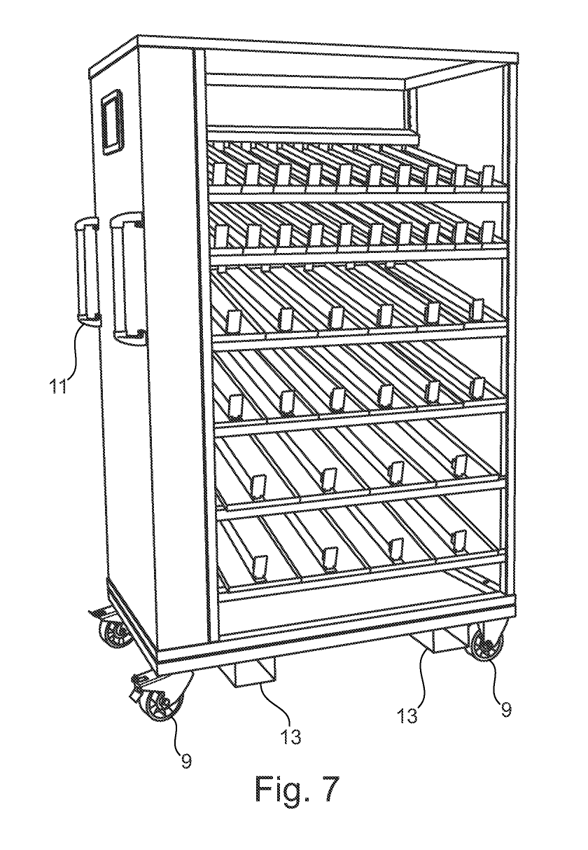

FIG. 7 shows a perspective view of a rack according to an embodiment of the invention, according to a further embodiment example.

FIG. 1 shows different products of an inventory management system: Firstly, inlay elements for drawers are mentioned, which can be laid in drawers as deep-drawn plastic inlays. However, the inlay elements may also be arranged in a rack. The inlay elements are available with 8, 10 and 16 compartments (or trays), and accordingly have different dimensions (or sizes). As a second product, paperboards (or paperboard packages) are mentioned, in which goods, for example bolts and nuts, can be stored. The paperboards are available in six different sizes. As a third product, plastic containers (a small load carrier having a rectangular bottom and four side walls) are mentioned, which are available in three dimensions. As a fourth product, small load carriers are mentioned, in which a side wall can be flapped. These small load carriers are available in three sizes.

All the goods of the inventory management system, which goods are envisaged for stockage in inlay elements, paperboards (or paperboard packages), plastic containers and small load carriers and/or which are envisaged at new accommodations of goods, are accommodated in the inventory management system in one of the inlay elements, paperboards, plastic containers and small load carriers, which are shown in FIG. 1. Thereby, a standardization of the product dimensions (or product sizes) is effected, which simplifies the handling of the inventory management system and particularly of a rack of the same.

FIG. 2 shows different constellations of products for a rack width, which is usable for products, of a rack of an inventory management system of 756 mm. In the first row, it is envisaged to arrange paperboards having a 90-sized width. The 90-sized paperboards have a width (outer dimension) of 93 mm. In FIG. 1, if one commences to fill in 90-sized paperboards from the left-hand side with to the right-hand side, then 91.5 mm remain as a “remainder” at the right-hand side. In the second row, if one commences, again from the left-hand side, to fill in plastic containers of width 103 having an outer width of 124.5 mm, then a remainder of 123 mm remains. In the third row, if one commences, again from the left-hand side, to fill in plastic containers of width 150 with an outer width of 156 mm, then a remainder of 123 mm remains. In the fourth row, if one commences, again from the left-hand side, to fill in plastic containers of width 210 having an outer width of 217.5 mm, then a remainder of 93 mm remains. In the fifth row, if one wishes to arrange paperboards of width 225 having an outer width of 249 mm on the right- and on the left-hand side, then a remainder of 258 mm remains in the centre. In the last row, two plastic containers B300 having an outer width of 312 mm are arranged, whereby a remainder of 124.5 mm remains.

FIG. 3 shows a perspective view of a product carrier 5 having two products 3, which are arranged on the product carrier 5. The product carrier 5 has a product carrier bottom 5B, a product carrier front side 5V, a product carrier rear side 5H as well as two product carrier sides 5S, the mutual distance of which defines a reception width 5A of the product carrier. A product pusher 3S on the product carrier 5 pushes the products 3 in the direction to and against the product carrier front side 5V, such that only products 5 are arranged between the product pusher 3S and the product carrier front side 5V, and such that these abut on one another without gap. If the length of the products in this direction (product pusher 3S—product carrier front side 5V) is known, then it is possible to determine the number of products on the product carrier 5, if one known the distance product pusher 3S—product carrier front side 5V.

A measurement device 5M is conceived on the product carrier 5 for measuring the distance [from the] product pusher 3S—[to the] product carrier front side 5V. The measurement device 5M comprises an ultrasound transmitter and receiver 5MS, SME, both of which are arranged at the product carrier rear side 5H of the product carrier 5. The measurement device further comprises a reflector 5MR, which is arranged on the product pusher 3S, for the ultrasound waves of the ultrasound transmitter 5MS.

Ultrasound waves that are transmitted by the ultrasound transmitter 5MS are reflected at the reflector 5MR and are echoed on the receiver SME. The measurement device 5M is capable to determine the distance between the transmitter and/or receiver 5MS, 5ME and the reflector 5MR on the basis of the resulting propagation time. Since the length between the product carrier rear side 5H and the product carrier front side 5V as well as the length of the product pusher 3S in this direction (between the reflector 3R and the abutment face of the product pusher 3S at the product 3) is known, the length between the abutment face of the product pusher 3S and the product carrier front side 5V can be calculated. Since the length of the product in this direction is also known, the number of products 3 on the product carrier 5 can be determined.

The measurement device 5M of the product carrier 5 is connected with a data logger via an electric cable (not shown), and the data logger is connected, via further cables, with still further product carriers 5. The data logger receives the respective measurement results of the run-time measurement of the ultrasound signal as well as an identification of the product carrier (herein an identification of the measurement device 5M, which transmits electronically a proper (own) identification and/or labelling together with the run-time signals) from all connected product carriers 5 in adjustable intervals. These data (which product carrier 5 and/or which measurement device 5M has measured which run-time) are transmitted wirelessly (for example by means of WLAN) or wire-bound to a (control) centre of the inventory management system. The calculation of the stock of products 3 on the product carrier 5, as sketched above, is effected in this (control) centre. If the stock of products falls below a predetermined limit, this is communicated, for example by mail (e-mail), to a person in charge of orderings of the inventory management system, whereupon this person may trigger a re-ordering. Alternatively, the re-ordering is triggered automatically.

Thus, each product carrier 5 is in connection with the (control) centre of the inventory management system via connection unit 7, herein the data logger and cables, in order to determine the stock of products on the product carrier and to trigger re-orderings as necessary.

A rack 1 according to an embodiment of the invention is shown in FIG. 4 as a front view, and in FIG. 5 as a side view. The rack 1 comprises two side elements 1S, herein formed by two metallic rack rods, as well as front and rear horizontal elements 1vH, 1hH, which connect the side elements 1S. The rack rods have a hole grid along their longitudinal extension, in which hole grid the horizontal elements 1vH, 1hH are plugged, wherein the [front] horizontal elements 1vH are arranged between the two front side rack rods, and the [rear] horizontal elements 1hH are arranged between the two rear side rack rods, with a height offset.

The horizontal elements 1vH, 1hH have a hole grid along their longitudinal extension, and the product carriers 5 have plug noses 5SN arranged at the product carrier bottom 5B, whereby the product carriers 5 are pluggable in the horizontal elements 1vH, 1hH, refer to FIG. 4 and FIG. 5. Due to the height offset between the horizontal elements 1vH, 1hH, there results the inclined arrangement of the product carriers 5, as is visible in FIG. 5, whereby products 3 on the product carrier 5 are pushed by gravitation and by the product pusher 38S to the front and/or downwards.

Now, in order to change a storage cell for a good, the product carrier 5 can be taken out of the rack 1 and plugged at another location in the rack 1 or in another rack 1. Since the measurement device including the associated electronics “relocates therewith” automatically, no further mechanical works are necessary. In the case that the position of the product carrier 5 in the rack is still tracked (or attended), then the relocation is still to be reproduced only there.

In order to assign a specific product to a product carrier 5, one proceeds as follows: All products 3 are taken out of the product carrier 5. Subsequently, the product pusher 3S is pushed in the direction of the product carrier rear side 5H up to a rear side abutment and is held there. The measurement device 5M records that the product pusher 3S abuts at the abutment, and transmits this to the centre of the inventory management system, which the centre is programmed such that this is interpreted as a new usage of the product carrier 5 with a new product 3.

On a control unit (for example a monitor screen at the rack 1 or in an App of a smartphone), an operator of the rack 1 can now select from the assortment of goods of the inventory management system the good in the product, which is now to be arranged on the product carrier 5. In the centre of the inventory management system, a new good in a product is then assigned to the product carrier 5. Since the dimensions (sizes) of each product are lodged in the (control) centre of the inventory management system, the centre calculates the stock of products 3 on the product carrier 5 as soon as the measurement device 5M of the product carrier 5 provides its data to the centre.

FIG. 6 shows a perspective view of a further embodiment of the rack 1 according to an embodiment of the invention, which differs from the embodiment described above in the following aspects: The rack 1 has, on its upper side, a UMTS antenna for connecting a data logger with the centre of the inventory management system. The side elements 1S are formed as metallic side panels. At the upper left section in the rack, there is arranged a control unit in the form of a pressure-sensitive monitor screen, on which the goods (inventory) of the inventory management system as well as the occupation of the rack 1 with product carriers 5 (i.e. which product carrier at which position in the rack) can be indicated. On the monitor screen, the actual state and the target state of products for each product carrier can be indicated, and the limit, upon the attainment of which a re-ordering is triggered, can be set. Furthermore, it is indicated, whether a re-ordering of products for the product carrier 5 has been triggered, and how many package units have been ordered.

FIG. 7 shows a perspective view of a further embodiment of the rack 1 according to an embodiment of the invention, which differs from the embodiment described above in the following aspects: The rack 1 has rollers 9 at the bottom of the rack and thereby is movable by means of handles 11. The pressure-sensitive monitor screen as the control unit is arranged in a side panel of the rack 1. A battery for the supply of the connection unit 7 with electrical energy is envisaged in the rack 1. The rack 1 has reception pockets 13 for the reception of forks of a forklift truck, in order to displace the rack 1 by means of a forklift truck.

In a further embodiment, at least one product carrier 5, or a shelf compartment respectively an inlay shelf having at least one product carrier 5, or a rack 1 according to an embodiment of the invention is arranged in a cabinet for hazardous substances, particularly an explosion-proof cabinet for hazardous substances. In a particularly explosion-proof cabinet for hazardous substances, there is thus arranged particularly a product carrier 5 for managing products 3, which are arranged therein, of the inventory management system.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

### LIST OF REFERENCE NUMERALS

1 rack of an inventory management system

1hH rear side horizontal element

1vH front side horizontal element

1S side element

3 product

3S product pusher

5 product carrier

5A reception width of the product carrier

5B product carrier bottom

5H product carrier rear side

5M measurement device of the product carrier

5ME receiver of the measurement device

5MR reflector of the measurement device on product pusher 3S

5MS transmitter of the measurement device

5S product carrier side

5SN plug nose

5V product carrier front side

7 connection unit

9 roller

11 handle

13 reception pocket

1. Rack of an inventory management system for providing products, comprising:
a. two side elements,
b. at least one front and one rear horizontal element,
i. wherein these connect the two side elements,
c. at least one product carrier for reception of same products,
i. which product carrier is plugged in the front and the rear horizontal elements, and
ii. has a distinct identification,
d. a measurement device for at least one product carrier,
i. which measurement device measures the filling level of the product carrier with products,
e. a connection unit, with which data from the measurement device concerning the filling level of the product carrier with products and the identification of the product carrier are transmissible to a centre of the inventory management system, in order to trigger re-ordering of products for a product carrier.

2. Rack according to claim 1, characterized in that a side element is a side panel or at least two rack rods, particularly made of metal.

3. Rack according to claim 1, characterized in that the horizontal element is a bar, in particular a metal bar, which preferably has a hole grid.

4. Rack according to claim 1, characterized in that a predetermined number of product carriers having different reception widths is assigned to the rack, wherein each of the products of an assortment of goods of the inventory management system has a size, which corresponds to a reception width of a product carrier.

5. Rack according to claim 1, characterized in that a product carrier has a product carrier bottom, two product carrier sides, a product carrier front side and a product carrier rear side as well as plug noses, which are preferably arranged at the product carrier bottom, opposite to the product carrier sides, and which are pluggable in a hole grid of the horizontal elements.

6. Rack according to claim 1, characterized in that the product carrier comprises a, particularly spring-loaded, product pusher, which pushes same products arranged on the product carrier in a direction of the product carrier front side.

7. Rack according to claim 5, characterized in that a reception width of the product carrier is formed by the distance of the product carrier sides.

8. Rack according to claim 1, characterized in that a ratio of a number of different goods of the inventory management system to a number of different product carriers of the rack is at least 100:1, preferably at least like 1,000:1, and more preferably at least like 10,000:1.

9. Rack according to claim 1, characterized in that a product is a paperboard, an aerosol can, a canister, a small load carrier with or without a removal flap or an inlay element, for example for a drawer.

10. Rack according to claim 1, characterized in that the measurement device comprises an ultrasound transmitter and receiver or a linear measurement device, in order to determine a length between the product carrier front side of the product carrier and a product pusher, between which same products are arranged, in order to determine the number of products between them and/or on the product carrier.

11. Rack according to claim 1, characterized in that the identification of the product carrier comprises an identification element on the product carrier, for example a bar code or a QR code, and/or an identification element in the measurement device, for example a MAC address, a bar code or a QR code.

12. Rack according to claim 1, characterized in that the connection unit comprises a data logger and a transmission medium, for example a wire-bound or a wireless connection line, to an inventory management system, such that the data of the measurement devices are collected by the data logger and are transmissible to a centre of the inventory management system by the transmission medium.

13. Inventory management system comprising a rack according to claim 1.
